(19) United States
(12) Patent Application Publication
(10) Pub. No.: US 2009/0168994 A1
(43) Pub. Date: Jul. 2, 2009

(54) Method for providing stronger encryption using conventional ciphers

(76) Inventor: Michael R. Heuss, Alachua, FL (US)

Correspondence Address: Michael R. Heuss, 6823 NW 218th Street, Alachua, FL, 32615, US

(21) Appl. No.: 12/316,909

(22) Filed: Dec. 18, 2008

Related U.S. Application Data
(60) Provisional application No. 61/009,039, filed on Dec. 26, 2007.

(51) Int. Cl. H04L 9/28

(52) U.S. Cl. 380/28

(57) ABSTRACT

A method of transforming files that will produce a much stronger encryption over conventional encryption methods.

### RELATED APPLICATION

This application claims priority to U.S. Provisional Patent Application No. 61/009,039 filed Dec. 26, 2007. The content of both of these applications is hereby fully incorporated herein by reference.

### COPYRIGHT NOTICE

A portion of the disclosure of this patent document may contain material which is subject to copyright protection. The copyright owner has no objection to the facsimile reproduction by anyone of the patent document or patent disclosure as it appears in the US Patent and Trademark Office patent file or records, but otherwise reserves all copyright rights whatsoever.

### FIELD OF THE INVENTION

The present invention relates to a method of transforming files that will produce a much stronger encryption over conventional encryption methods. Using any standard encryption cypher, a one megabyte file will be rendered 40,000 times more secure by applying the described methodology compared to a file encrypted without the method.

### BACKGROUND OF THE INVENTION

The invention is an improved process for encrypting data in such a way that greatly increases the data's security. This process makes use of standard encryption ciphers, but in a novel and unique way.

### SUMMARY OF THE INVENTION

Data to be encrypted is compressed and then broken down into chunks the same size as the encryption key. A password provided by the user is combined with certain data taken from the encryption archive, the encryption cipher, and from the source data being encrypted. This password is then transformed, hashed with a strong hashing algorithm, and used to encrypt a single block of data. Each subsequent block of data is encrypted with a different password generated in the identical way. Additionally, each block of data can be encrypted with a unique encryption cipher. This is useful in that it increases obfuscation.

The key improvements over conventional encryption methods are as follows:

a. The file to be encrypted is first broken into very small chunks of data. Each chunk to be encrypted is no bigger (e.g. contains no more characters) than the encryption key.

b. Each chunk of data is encrypted multiple (at least three) times with a unique password, derived from the original password in a cryptographically secure way. The derived passwords are hashed with data derived from the encryption archive and the source data being encrypted using a strong hashing algorithm, meaning that it is impossible to deduce the original password if any of the derived passwords are compromised.

c. Each chunk of data can be encrypted with a unique encryption cypher. This serves to increase obfuscation.

### BRIEF DESCRIPTION OF THE FLOW CHART

The attached chart shows the process flow at a general level. Each major step is represented: compression of the file, breaking the file into chunks, encrypting each chunk, calculation and manipulation of the password, rotation of the encryption types and the calculation of a hash to allow for integrity checks.

### DETAILED DESCRIPTION OF THE INVENTION

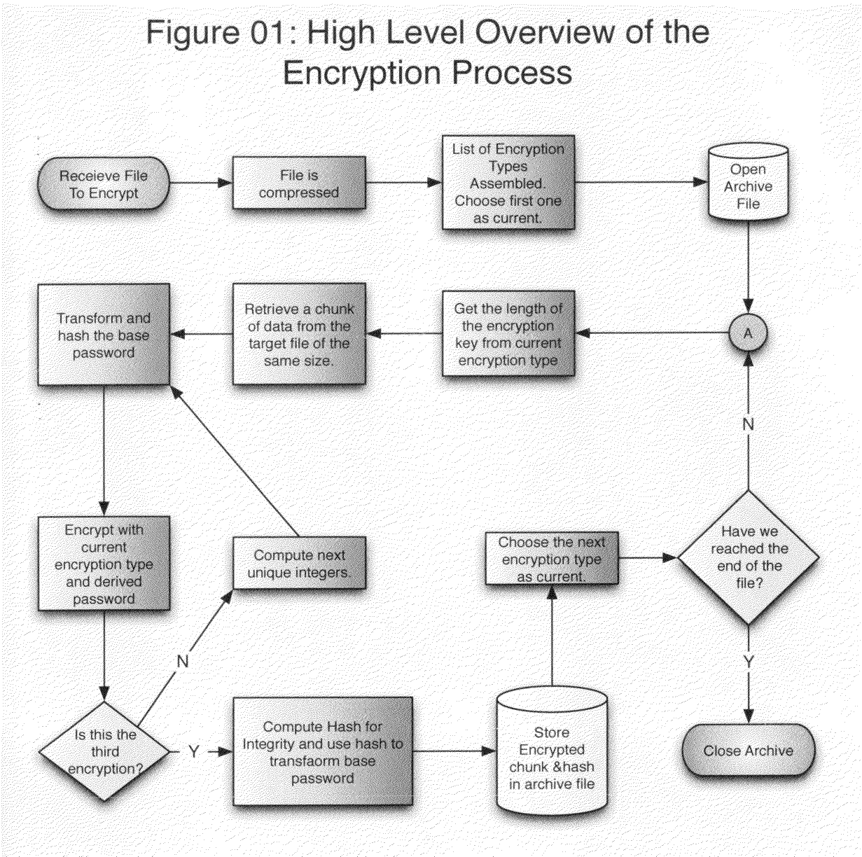

As shown in FIG. 1.0 there are thirteen steps involved in the encryption process as follows:
Step 1: A file to be encrypted with this method is first compressed. Current implementations of the method compress with alternating compression mechanisms—namely GZIP, BZIP2, and LZMA—but the particular compression algorithm is unimportant.
Step 2: A list of encryption ciphers to be used is generated. The source for this list can be user input, or it can simply be all supported ciphers. In current implementations, each cipher has at least a 256b key length.
Step 3: The first cipher in this list is considered the current cipher.
Step 4: An archive file is opened on the disk.
Step 5: The password supplied by the user is given a default transformation by hashing it with two different strong hashing algorithms. This hashed password is considered the base password from which all future transformations will be derived.
Step 6: A counter variable is set to 0.
Step 7: A chunk of data from the compressed file equal to the length of the encryption cipher key is read into a buffer. If the last chunk of data is being encrypted, the file length may be less than the length of the encryption cipher key.
Step 8: A copy of the base password is made. The counter variable is appended to the copy, as is information concerning the file to be encrypted, information from the archive, and information concerning the cipher and compression algorithm used. The entire appended string is hashed using a strong hashing algorithm and saved as the one-use password.
Step 9: This one use password is used with the current cipher to encrypt the data.
Step 9a: One implementation takes advantage of multiple encryption, meaning that the same current cipher and the method described in Step 8 is used to encrypt the data multiple times (at least 3). In such a scenario, the one use password also contains data which corresponds to the round of encryption - and each subsequent encryption round starts with the former password, transformed and hashed with a secure hashing algorithm.
Step 9b: Another implementation uses a cascading encryption scheme, where, after each chunk of data is encrypted, we advance to the next cipher on our list, for at least three (3) ciphers. Again, in this scenario, we utilize the method described in Step 8 with the former password from the previous cipher as the base for transformation and hashing to derive a new one use password.
Step 10: After the file is encrypted, it is stored in the archive file, along with a hash of the encrypted data to serve as a checksum.
Step 11: The base password is then reset to the base password plus the hash of the encrypted data. The counter variable is incremented. The current encryption cipher is changed to the next cipher available on the list.
Step 12: We then check to see if there is more data to encrypt, or if the file is complete. If there is more data, we go back to Step 7.
Step 13: If the file is complete, we close the archive.

The strength of this approach is that it applies key elements of a one-time pad, namely that the data to be encrypted is the same length as the encryption key. Additionally, it adds multiple levels of obfuscation to any attacker, who must discern the hashing and compression algorithms and encryption ciphers used. Decrypting the same file is done with the steps in reverse, with the added consideration: The data to be decrypted is hashed and then compared to the checksum. If it does not match, it can be assumed that the data has been modified and appropriate action can be taken.

Having thus described the invention in detail, it should be apparent that various modifications and changes may be made without departing from the spirit and scope of the present invention. Consequently, these and other modifications are contemplated to be within the spirit and scope of the following claims.

We claim:

1. A method of data encryption whereby the data to be encrypted is the same length as the encryption key and whereby a user supplied password is hashed together with additional data to create a one-use password.

2. The method of claim one whereby additional data includes:
a. the counter variable,
b. information concerning the file to be encrypted,
c. information from the archive,
d. information concerning the cipher, and
e. the compression algorithm used.

3. A method of data encryption utilizing multiple levels of obfuscation whereby obfuscation includes the hashing algorithms, compression algorithms, and encryption ciphers used.

4. The method of claim 3 whereby encryption is performed multiple times using data which corresponds to the round of encryption and each subsequent encryption round starts with the former password, transformed and hashed with a secure hashing algorithm.

5. A method of data encryption whereby the first file is encrypted using the following steps:
a. Step 1: A file to be encrypted is first compressed, and whereby
b. Step 2: A list of encryption ciphers to be used is generated, and whereby
c. Step 3: The first cipher in this list is considered the current cipher, and whereby
d. Step 4: An archive file is opened on the disk, and whereby.
e. Step 5: A supplied password is given a default transformation by hashing it with two different strong hashing algorithms and whereby this hashed password is considered the base password from which all future transformations will be derived, and whereby
f. Step 6: A counter variable is set to 0, and whereby
g. Step 7: A chunk of data from the compressed file equal to the length of the encryption cipher key is read into a buffer, and whereby
h. Step 8: A copy of the base password is made and the counter variable is appended to the copy, as is information concerning the file to be encrypted, information from the archive, and information concerning the cipher and compression algorithm used, and whereby the entire appended string is hashed using a strong hashing algorithm and saved as the one-use password, and whereby
i. Step 9: The one use password of Step 8 is used with the current cipher to encrypt the data a first time and whereby the same current cipher and the method described in Step 8 is used to encrypt the data multiple times and whereby the one use password also contains data which corresponds to the round of encryption and each subsequent encryption round starts with the former password, transformed and hashed with a secure hashing algorithm, and whereby
j. Step 10: After the file is encrypted, it is stored in the archive file, along with a hash of the encrypted data to serve as a checksum, and whereby.
k. Step 11: The base password is then reset to the base password plus the hash of the encrypted data, the counter variable is incremented, and the current encryption cipher is changed to the next cipher available on the list.
